(19) United States
(12) Patent Application Publication
(10) Pub. No.: US 2010/0017255 A1
(43) Pub. Date: Jan. 21, 2010

(54) Fee estimation tool

(76) Inventors: Thomas Daniel Gramza, Boston, MA (US); Barbara Lynn Kolts, Uniontown, OH (US); Brian Patrick Kolts, Uniontown, OH (US)

Correspondence Address: Nields, Lemack & Frame, LLC, 176 E. Main Street, Suite #5, Westborough, MA, 01581, US

(21) Appl. No.: 12/459,984

(22) Filed: Jul. 10, 2009

Related U.S. Application Data
(60) Provisional application No. 61/135,016, filed on Jul. 16, 2008.

(51) Int. Cl. G06Q 10/00; G06Q 40/00

(52) U.S. Cl. 705/9; 705/400; 705/30; 705/11

(57) ABSTRACT

A system for generating proposals, managing projects and reporting is disclosed. The present invention allows the user to perform several important functions. First, the software aids the user in estimating costs for a proposal, based on the number of personnel who are anticipated to the employed in the proposed project. Based on this, the program will allow the user to calculate fees, based on hourly billable rates. Additionally, the program can track utilization of all individuals, departments and contractors to determine excessive idle time or overload situations. The software can also be used to enter and track all costs for the project, including billable hours, contractors, materials, etc. The software allows the user to save past proposals and projects for historical and analytical purposes. A database is created from which the user is able to review past proposals, specifically similar ones, in order to better prepare current and future proposals.

This application claims priority of U.S. Provisional Application No. 61/135,016 filed Jul. 16, 2008, the disclosure of which is incorporated herein by reference.

### BACKGROUND OF THE INVENTION

In many fields, customers solicit RFPs (Request for Proposals) for new projects from the potential suppliers. Often times, these RFPs ask the supplier to detail costs to a level of accuracy which is not available at the commencement of the project. Typical information requested may include material costs, manpower costs, headcount involved, schedule, and other fees. Potential suppliers respond to these RFPs by using, in many cases, their best estimate of what the project may take, based on experience, previous similar projects or other nebulous criteria.

Some industries, particularly the construction industry, have developed software tools to help increase the accuracy of their responses. In fact, numerous patents and applications exist which are focused on the construction bid process. In some ways, the construction bid process is relatively straightforward. Software tools are able to estimate the amount of lumber (i.e. 2×4s, 2×6s, plywood sheets, etc) as a function of building size, number of stories, and other known metrics.

However, other industries have been far less successful in estimating costs. For example, returning to the construction scenario, often an engineering firm will receive a RFP from an architect, a building owner, or a developer. The RFP typically gives an overall description of the project, including such parameters as estimated building size, estimated construction costs, and the design services that are required. These design services include, but are not limited to architecture, MEP engineering, structural, civil, and environmental engineering. Based on this limited information, the engineering firm has to estimate a fee to design their portion of the project and to review the installation of their systems throughout the construction of the building. This estimate forms the basis of the proposal.

Typically, the level of detail presented in an RFP varies greatly, but most often they are vague, thus making it very difficult for an engineering firm to estimate a design fee based solely on the information provided in an RFP.

As a result, fee estimation is a guessing game for engineering firms. If the estimate is too high, the firm will not be awarded the project, since they are bidding against other firms. If the estimate is too low, the firm will be awarded the project, but will lose money fulfilling their obligations. Often, engineering fees are based on industry guidelines, or “rules of thumb”, based on the construction cost of the project or the square footage of the project. However, each of these “rules of thumb” is not perfect, since they do not take into account extenuating circumstances. For example, a glass skyscraper having the same square footage as a wood warehouse may have significantly different engineering costs, not captured simply by looking at the square footage.

While the previous description specifically describes the issues confronting engineering firms involved in the construction business, the problem is not limited to this field. Any occupation that is required to respond to RFPs that include a high labor-intensive component is susceptible to the issues described above. For example, service based industries, such as Information Technology (IT) and consulting, are often asked to provide RFPs.

To improve the accuracy of their estimations, companies need a tool that can assist corporations in responding to RFPs, particularly those that are labor intensive.

### SUMMARY OF THE INVENTION

The problems of the prior art have been solved by the present invention, which discloses a system for generating proposals, managing projects and reporting.

The present invention allows the user to perform several important functions. First, the software will aid the user in estimating costs for a proposal, based on the number of personnel, sub-contractors, etc., who are anticipated to the employed in the proposed project. Based on this, the program will allow the user to calculate fees, based on hourly billable rates. Additionally, the program can track the utilization of all individuals, departments and contractors to determine excessive idle time or overload situations.

If the submitted fee is accepted, the firm may then use the software to enter and track all costs for the project, including billable hours, contractors, materials, etc. This allows the firm to monitor deficiencies/proficiencies in their manpower estimations, and track the financial status of the project.

Finally, the software allows the user to save past proposals and projects for historical and analytical purposes. A database is created from which the user is able to review past proposals, specifically similar ones, in order to better prepare current and future proposals. Likewise, the user may review past proposals to understand the desirability of new RFPs in terms of financial return.

### BRIEF DESCRIPTION OF THE DRAWINGS

FIG. 1 shows one embodiment showing a view of the company data as can be displayed to the user

FIG. 2 illustrates a simple flowchart showing the generation and storage of a proposal.

FIG. 3 details the procedure for elevating a proposal to a project and for tracking and editing projects.

### DETAILED DESCRIPTION OF THE INVENTION

The present invention is preferably implemented as a software program, which can be run on a variety of platforms, including but not limited to Windows, Macintosh OS, Linux, Unix and others. The software program will preferably present an intuitive graphical interface to the user. The software program can be loaded onto a computing device, such as a personal computer or server, in any of a number of ways, including but not limited to CD, DVD or internet download. The software program may be written in any programming language, including Perl, Visual Basic, java, or any other suitable language.

The user interface for the software preferably contains dropdown menus that enable the user to quickly navigate the various features and functions of the program. In addition, the software may also have keystroke shortcuts or icons to facilitate faster navigation. Graphical interfaces and menu navigation techniques are well known in the art and will not be described in more detail.

Since a primary purpose of the present invention is manpower allocation and estimation, the software program requires the user to enter parameters about the user's entity or company. Company data, or the entity's organizational structure, can include, but is not limited to the names and functions of the departments within the company, the personnel within each department, the billing rates for each person, and the expertise or skills associated with each department and/or person.

The term “user” shall refer to any person operating or utilizing this software program. This includes, but is not limited to, the person responsible for generating the fee estimate, a project manager tracking the status of a project, or a resource planner.

The user can enter the aforementioned company data, or entity's organizational structure, such as via a wizard that leads the user through the process. The wizard directs the user to enter information concerning the company, such as but not limited to number of employees, number of departments, expertise and experience of each employee. In one embodiment, a company or entity is presumed to consist of multiple departments, each with one or more employees. However, the invention is not so limited. There can be more layers of organizational hierarchy, such as divisions, sections, and departments. Alternatively, the company or entity may have no layers of organizational hierarchy and simply consist of number of employees. Finally, the program also allows the user to enter independent contractors or consultants that may be working for the company.

The wizard preferably then asks for the number of layers of hierarchy, with a preferred default value of 2. It then guides the user through a series of prompts that allow the program to create an organizational tree or matrix. Such a tree describes the layers of hierarchy and the interrelationship between them. One simple tree is illustrated below:

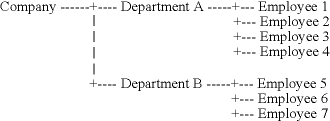

In this simple example, the company consists of 2 departments, where the first has 4 employees and the second has 3 employees.

A much more sophisticated tree is also possibly where there are more layers of hierarchy with varying numbers of entities in each layer.

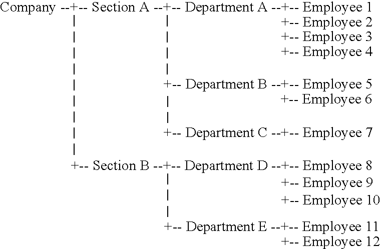

In this example, the entity has 2 sections, each with a number of departments within that section. The first section has 3 departments, with 4, 2 and 1 employees, respectively. The second section has 2 departments, having 3 and 2 employees, respectively. Other corporate hierarchies are possible and contemplated by the present invention. These examples are not intended to limit the invention; they serve only to illustrate several possible hierarchical models that can be created.

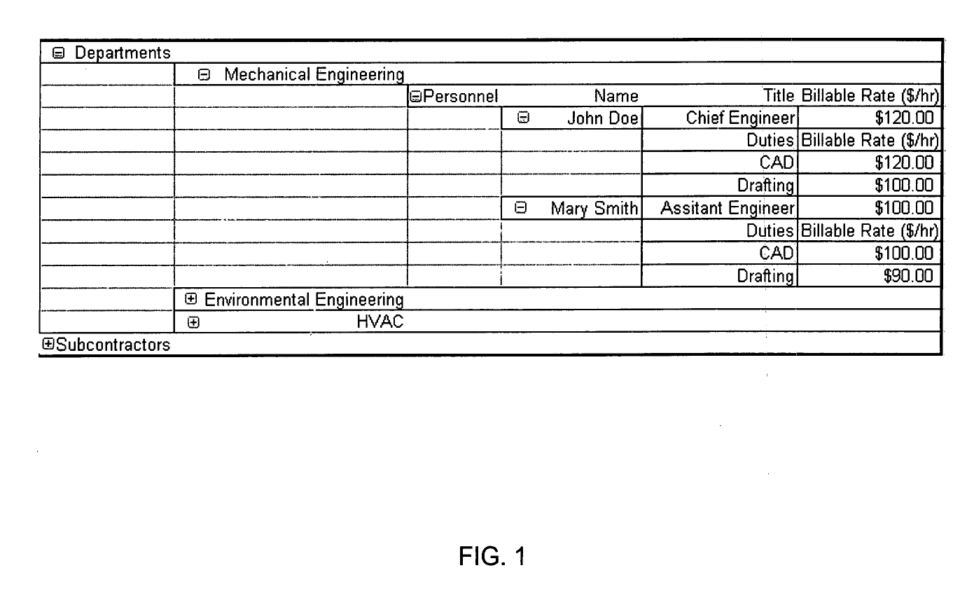

As the user enters information as requested by the wizard, the software program builds a company database. FIG. 1 shows one embodiment showing a view of the company data as can be displayed to the user. Note in this view, three departments are shown, each with a small + or − icon preceding the name. These icons, which are used in a wide variety of applications, allow the user to expand or condense the company view of that particular department. In this Figure, the Mechanical Engineering Department has been expanded showing the employees in that department, and their billable rates. Other departments, Environmental Engineering and HVAC, have been condensed, so the internal structure of those departments is not visible.

FIG. 1 shows the various duties that each employee is capable of. For example, both John Doe and Mary Smith are qualified to perform CAD or drafting services. FIG. 1 also shows the billable rate for each engineer. Note that the billable rate can be a function of the task required. In both cases, the billable rates of the employees are higher for CAD services. It is preferred that the information for each employee contains, at a minimum, the billable rate for that employee and the types of services that that employee can perform. Additionally, other parameters, such as but not limited to specialized expertise, billable hours per week, etc. can be associated with each employee.

Wizards are utilized in a wide variety of applications and are well known in the art. While the use of a wizard is the preferred method of inputting the company data, other methods are possible. For example, a blank spreadsheet can be provided onto which the user enters the various data fields. In the scenario shown in FIG. 1, the spreadsheet would include fields such as Name, Duties, Billable Rate, Title, and Department. Other methods of inputting data are well known and are within the scope of the present invention.

Once the Company Data profile has been completed, it can be readily updated as employees join or leave the company. Again, modifications can be made via that wizard or some other input mechanism.

A completed Company Data profile is a precursor to utilizing many of the features of the present invention. Once this profile has been created, the software program can be utilized to track, estimate, and manage a variety of tasks.

As stated above, the software program has a variety of functions. One such function is to assist in the creation of proposals, such as those in response to an RFP. The software program is not intended to help one write the proposal, but rather to help the user calculate the cost for the intended project. The proposal function allows the user to calculate the costs of the project, based on billable manhours and other costs such as travel, shipping, courier, copying, etc. Once the total cost of the proposal is generated, the user can determine the appropriate amount of margin or profit to add to the cost to generate a final bid amount.

The proposal function allows the user to enter certain parameters associated with the project, such as but not limited to project name, project location, client name and contact information, proposal creator's name and contact information, project scope, brief project description, project schedule, and general comments. In the case of a building engineering firm, additional information such as estimated construction cost and the square footage of the project may also be included. Typically, most of this information is available from the RFP itself. The user may also enter keywords, which help to define the proposal. These keywords allow the user to compare similar proposals, based on common keywords.

Once the Company Data is entered, the user is now able to use the program to facilitate in the estimation of fees for an RFP. In the preferred embodiment, a wizard guides the user through the various departments within the company, based on the hierarchical information input into the Company Data. For each department, the wizard will prompt the user to enter data associated with that department.

In one embodiment, the user will estimate the types of services required, and the number of hours necessary. Referring to FIG. 1, the user may estimate that 35 hours of CAD services are required. Similarly, any other skill or expertise (like HVAC engineering, drafting, etc) can also be entered in this way. The program will then use the hourly rates associated with each skill or expertise to arrive at an estimated cost. In a further embodiment, the program also attempts to assign the various services to a qualified employee, based on a match in expertise and the availability of that employee. The program will also notify the user if there are no resources having the requisite skill that are available to work on the project.

In an alternative embodiment, the user can enter specific employee's names as part of the response. In this scenario, the program will use the hourly rates associated with each employee to arrive at an estimated cost. The program will also notify the user if the requested employee is unavailable and optionally, may suggest an alternate qualified employee.

This process continues until all departments have been considered. Again, although a wizard is the preferred mechanism, other input mechanisms can be used without departing from the spirit of the invention.

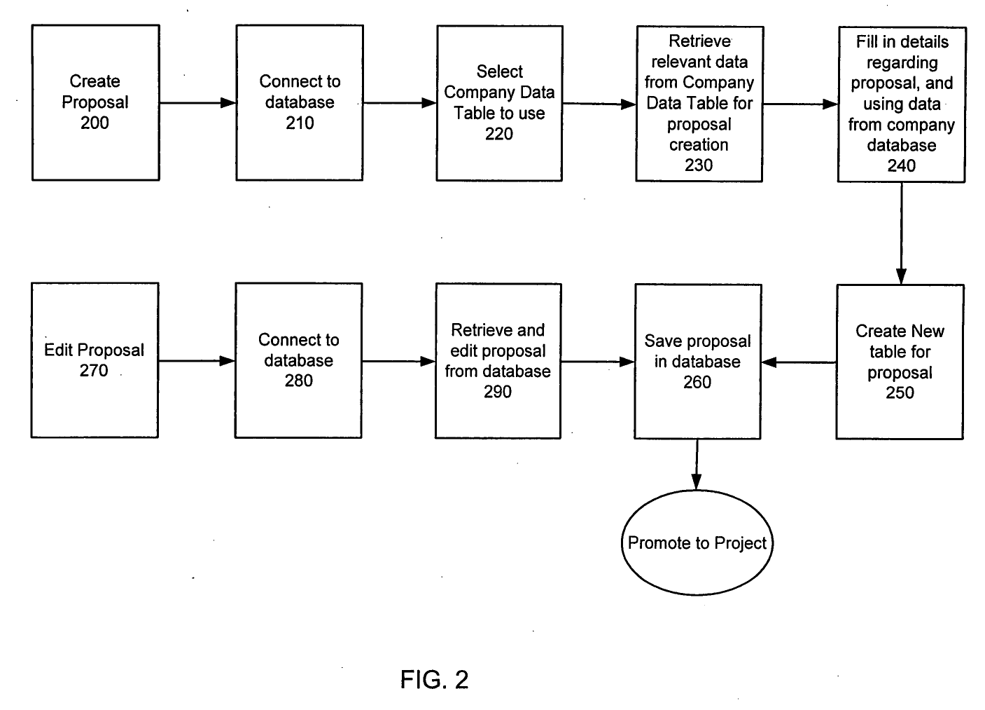

The present invention also allows the user to return to an incomplete proposal, or to edit a completed proposal as new information becomes available. FIG. 2 illustrates a simple flowchart showing the generation and storage of a proposal. Box 200 is the beginning of the proposal process, where the user begins creation of a new proposal. In the preferred embodiment, a dropdown menu is used to select this option. In another embodiment, a keystroke sequence can also be used to begin this process. In Box 210, the software program connects to the database or other storage element where the Company Data has been stored. In Box 220, the user selects among one or more Company Data profiles. In Box 230, the relevant details from the selected Company Data are uploaded into the software program. These details include departments, personnel, billable rates, and other information described above. The user then enters the appropriate data regarding the proposal in Box 240. The new proposal is then saved in a file in Box 250. The proposal is then saved in the database in Box 260. It is important to note that the entire proposal need not be entered at once.

Via a dropdown menu or keystroke sequence, the user can also edit an existing proposal, as shown in Box 270. The software prompts the user to enter the proposal that he desires to edit, either by typing the name, or displaying a list of the currently saved proposals. Once the user has entered the proposal name, the program connects to the database, in Box 280. The proposal is then retrieved from the database and made available to the user for editing, as shown in Box 290. Once the user has completed the required input, the proposal is then saved again, as shown in Box 260.

Once the wizard has allowed the user to input information concerning all of the departments or functions within the company, it can perform a variety of checks. As stated above, the first check is to verify the availability of the required resources. If a particular requested employee is unavailable due to a work overload (for example, the employee is being asked to work in excess of 40 hours per week), the program will alert the user, and optionally, suggest a qualified alternate employee.

The program is also capable of performing a variety of parameter checks, based on the user's business. Thus, the program can implement rules-based checks. For example, in the case of construction engineering firms, their fees typically have some relationship to the overall construction cost and/or the overall building size. In this scenario, the user is able to enter a rule defining the relationship between the engineering fee and the overall construction cost. In one embodiment, the user enters a single value (x) and a variance (y), such that the fee should be x % of the construction costs, +/−y %. Alternatively, the user may enter a range having a minimum value (s) and a maximum value (t), such that the fee should be between s % of the construction cost and t % of the construction cost. If the calculated fee is outside the targeted range, the user will be alerted. Other rules are also possible. For example, for a construction-engineering firm, the fee may have a relationship to the overall size of the building. Using the techniques described above, a rule can be entered defining the acceptable ratio of fee to building size.

These are not the only rules, but are presented as an example of the type of rules that can be used by the software program to alert the user of potential discrepancies.

Once the data has been entered, the software program provides a total personnel cost for the proposal, using the formula:

$$Personnel cost = {\sum }_{P = 0}^{n} ( B * H )$$

Where:
P=personnel number;
B=billable rate; and
H=estimated hours.

The present invention also allows the use of history, in the form of previous proposals, as a comparison to the derived personnel cost. In the preferred embodiment, previous proposals are saved in an archive or database, which remains accessible to the software program. When a new proposal is generated, the user has the option of comparing its cost to that of similar prior proposals. A variety of criteria can be utilized to determine whether two proposals are similar. These criteria in the case of a construction-engineering firm include, but are not limited to, size of building, estimated construction cost, or building type. For example, projects may be considered similar if they are within a predetermined variance of one another, based on one or more selected criteria. Additionally, the types of services performed can be compared to determine whether two projects are similar.

Based on one or more of these criteria, similar proposals are retrieved from the database and compared to the fees in the current proposal. This comparison need not be based exclusively on absolute cost. Cost indices can be used. For example, the comparison can be based on cost per square foot, cost as a percentage of construction cost, or other metrics. If the current proposal differs from the prior proposal by more than a predefined amount, the user will be alerted so as to allow the two proposals to be manually compared to understand the discrepancy.

The present invention also allows the user to compare proposals based on user-entered keywords. These keywords are user defined and allow the user to mark each proposal with special attributes. For example, keywords may include the name of the architect, the name of the client, the type of structure, etc. To compare similar proposals, the user enters one or more keywords. As is common with search engines, logic symbols (such as AND, OR, and NOT) can be used to further define the type of proposals that the user regards as similar to the current proposal. Based on the keywords entered, the attached database will retrieve those proposals deemed to be similar to the current proposal. These archived proposals and the current proposal can then be compared, either by comparing the actual costs or by using any of the criteria described above.

In addition to the rules-based checks performed during the proposal phase, additional checks can also be performed. For example, the user can be notified if an atypical percentage of a fee is assigned to one department. For example, the user may be flagged if the percentage of a fee assigned to one department exceeds a maximum threshold or is lower than a minimum threshold. The user can then view the previously entered data to determine if it is acceptable. Such a check can also be provided for individual employees. In another embodiment, this check is performed against other similar proposals and projects and the user is notified if the department usage differs from similar projects by more than a predetermined threshold.

The program preferably also allows the user to generate a very quick quotation, based on several criteria. As stated above, various checks can be performed to alert the user when a quote may be unusually high or low. These same checks can be used to generate a quick quotation. For example, one of the checks listed above was the ratio of the fee generated to the construction cost. Thus, the quick quote can use the typical value to compute the fee based on the construction cost. A similar approach may be used to base the quotation on the square footage of the proposed project.

The ultimate purpose of this part of the software program is to allow the user to create the cost estimates necessary to submit a bid on a specific project. After the bid is presented, there are two possible outcomes; the bid is either accepted or rejected.

If the proposal is rejected, there is little left to do. In one embodiment, the proposal has a field that enables the user to identify whether the proposal was accepted or rejected, and to enter notes, such as reasons for the decision. In the case of a rejection, the user edits the proposal, using the process described in conjunction with FIG. 2, enters the necessary information regarding the decision and saves the proposal.

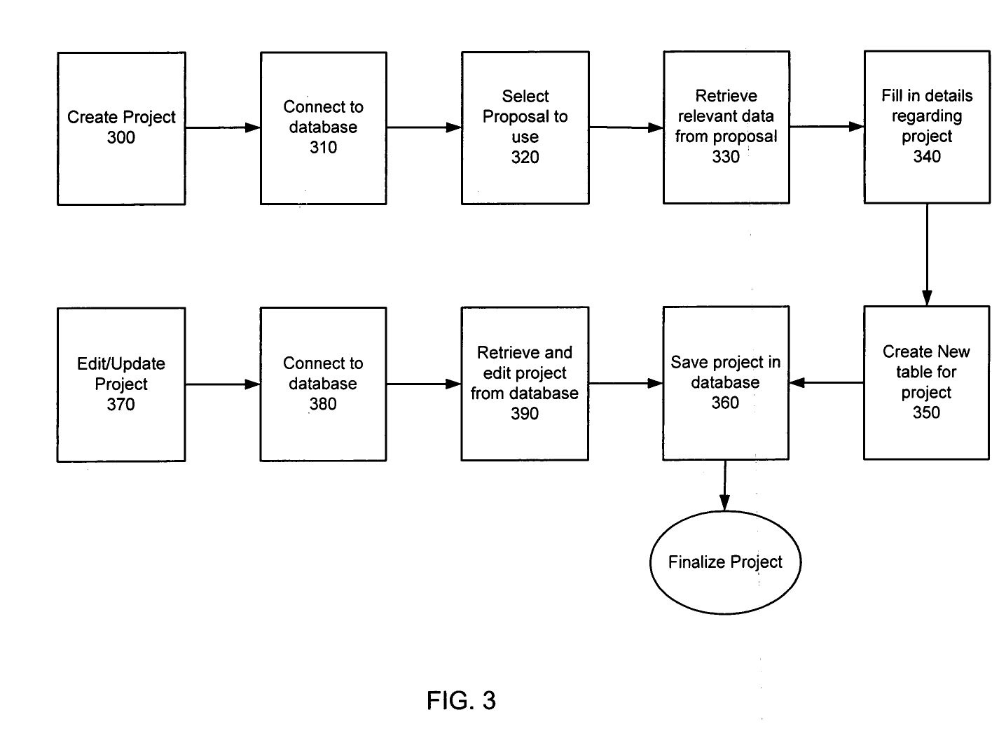

If the proposal is accepted, the information described above may also be entered. The present invention preferably also includes a second function, that of project tracking. Once a proposal is accepted, it can be elevated to the status of “project”. This can be achieved in a number of ways, including via a dropdown menu or through keystroke entry. One such method is shown in FIG. 3. FIG. 3 details the procedure for elevating a proposal to a project and for tracking and editing projects.

Box 300 is the entry point to the elevation of a proposal to a project. In one embodiment, a dropdown menu offers the user the option to “Create Project” or “Elevate Proposal”. Once the user selects this option, the software program connects to the database, as shown in Box 310. The program then allows the user to enter the name of the proposal, either via keystrokes or by presenting a list of proposals currently in the database. The user then selects the proposal, as shown in Box 320. The program then uploads all of the relevant data from the proposal into the project template, as shown in Box 330. This data may include square footage, cost of construction, building type, client, services to be provided, and other information captured in the proposal. Details regarding the project, such as expected completion date, are then entered by the user in Box 340. The project is then saved in the database in Box 360. It is important to note that the entire project need not be entered at once.

Via a dropdown menu or keystroke sequence, the user can also edit an existing proposal, as shown in Box 370. The software prompts the user to enter the project that he desires to edit, either by typing the name, or displaying a list of the currently saved projects. Once the user has entered the project name, the program connects to the database, in Box 380. The project is then retrieved from the database and made available to the user for editing, as shown in Box 390. Once the user has completed the required input, the project is then saved again, as shown in Box 360.

Once a project is created, it can be continuously updated and edited. For example, if approved additional services have been agreed upon by both parties, items such as base fee or the scope of services may have to be modified. Such changes may also affect the resource planning, thus the user may have to redistribute or increase the hours assigned in the proposal.

A project allows the user to maintain a current view of the project's status, both in terms of capital and personnel expenditures. At any interval, including daily, weekly or irregularly, the user may update the project by entering the actual time billed by the various personnel assigned to the project. Additionally, the user may enter any capital expenditures that have been made on behalf of the client. This allows the user to maintain an accurate, up to date, estimate of the project. This allows the user to monitor the financial performance of the project in real time and determine the amount of fee and expenses available for the life of the project, in dollars or as a percentage of the total available. This also allows the user to understand potential budget overruns or shortfalls well in advance.

Based on the approved budget for the project, the user can determine a budget for the project and can divide the budget among departments, preferably down to the individual, using the data entered during the proposal phase. Once these budgets have been set, the user is able to monitor the large-scale budget, including the smallest expenditure to insure that the project stays on budget. This tool also allows the user to see the strengths and weaknesses of the project, the firm and the estimating process.

The present invention preferably also includes analysis tools that can be used to analyze past and present projects and proposal. These tools can be used to analyze any proposal or project stored in the database. This allows users to compare any metric and display the output graphically. These graphs can then be saved or printed as desired.

Additional features are also included in the invention. For example, the Fee Backlog feature will report the amount of fee remaining for a project, broken down monthly for the life of a project. It is typically important for an office manager to know the amount of fee available for each project so that upcoming invoicing for the office and future revenue stream can be forecast. This projected revenue stream can be extremely valuable in assessing short and long-term staffing needs.

Project managers will also find the fee backlog analysis feature useful for scheduling manpower needs that coincide with actual available fee, limiting the chances that time spent will exceed the available fee budget.

A monthly fee backlog estimate is typically dependent upon the following variables:
Project stages (i.e. Design Development, Construction Documents, Construction Administration)
Duration (in months) of each project stage
The allotment of total fee to each project stage (as a percentage of total fee)
The disbursement of fee within each project stage (for example, is the fee allotted evenly during a particular stage or is it front or back loaded?)
   For example, if a Project has a total available fee of $100,000, and this fee is expected to divided evenly over each month of each phase as follows:
Design Development—20% of total fee—duration of 2 months
Construction Documents—50% of total fee—duration of 4 months
Construction Administration—30% of total fee—duration of 6 months
   Based on this, fees would be allocated as follows:
   Design Development=20% of $100,000, or $20,000, divided over 2 months, or $10,000 per month.
   Construction Documents—50% of $100,000, or $50,000, divided over 4 months, or $12,500 per month.
   Construction Administration—30% of $100,000 or $30,000, divided over 6 months, or $5,000 per month.

When properly displayed, as shown below, this tool gives an office manager a snapshot of available fee and anticipated revenue stream over the course of this Project:

| | Month # | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Available | 10000 | 10000 | 12500 | 12500 | 12500 | 12500 | 5000 | 5000 | 5000 | 5000 | 5000 | 5000 |
| fee ($) | | | | | | | | | | | | |

The inputs to the tool can be adjusted at any time. Thus, if the total available fee is adjusted during a Project, or if the desired disbursement of fee among stages or within a stage changes, then this feature can be adjusted by the user while the Project is active, thereby generating a revised fee schedule.

Another tool monitors personnel resources. As described above, during proposal creation, hours are assigned to particular individuals, who are categorized by department. With this information entered, the Personnel Analysis Tool will add and summarize the number of hours, the amount of fee dollars, and the percentage of total available fee assigned to each department. It is typically important for an office manager to know which departments within the office may be overloaded or under-utilized. If all current Projects in the database were queried at any given time, this tool can assess departmental staffing needs. For example, departments operating consistently under their maximum utilization may be targets for downsizing, while departments operating at their maximum utilization may be targets for additional hiring.

Project managers may also find it useful to know the percentage of total fee allotted to each department. This can be used as a check against past projects during the Proposal Creation to determine if the fee breakdown per department is within a typical range.

At the end of a project, the user can enter the actual fee used for the life of a Project, compare it to the estimated fee, and report the difference as a percentage. For example if the actual fee was within 10% of the estimated fee, the project was successful. Alternatively, if the actual fee exceeds 100% of the estimated fee, the user can use this as an opportunity to improve the estimating process. This tool will help managers identify these problems, and assist them in determining if it was a case of poor management, a bad client, or just a project type that is not best suited for the user's company.

What is claimed is:

1. A system for use by an entity for calculating a fee for a personnel-based project, comprising:
a. A computer readable medium comprising computer executable instructions comprising:
i. Means for a user to enter data associated with said entity's organizational structure;
ii. Means for a user to enter parameters associated with said project; and
iii. Means for calculating said fee.

2. The system of claim 1, wherein said means for computing said fee further comprises:
a. Means for a user to enter estimated workload for personnel within said entity for said project; and
b. Means for calculating said fee based on said estimated workload and said data associated with said entity's organizational structure.

3. The system of claim 2, further comprising:
a. Means for entering industry fee guidelines;
b. Estimating a fee by applying said fee guidelines to said entered project parameters; and
c. Alerting said user if said computed fee differs from said estimated fee by more than a predetermined threshold.

4. The system of claim 2, further comprising:
a. Means for entering data concerning past projects into a database;
b. Means for accessing said database;
c. Means for comparing said entered project parameters to said past projects in said database to find comparable projects;
d. Means of estimating said fee based on fees associated with said comparable projects; and
e. Alerting said user if said computed fee differs from said estimated fee by more than a predetermined threshold.

5. The system of claim 2, wherein said entered workload comprises hours for each employee within said entity, and further comprising means for alerting said user if workload for any of said employees is outside a predetermined range.

6. The system of claim 2, wherein said entered workload comprises hours for each employee within said entity, and said entity's organizational structure comprises associating each employee with a department, further comprising means for alerting said user if the workload for any of said departments is outside a predetermined range.

7. The system of claim 1, wherein said means for computing said estimated fee further comprises:
a. Means for entering industry fee guidelines;
b. Means for calculating said fee by applying said fee guidelines to said entered project parameters.

8. The system of claim 1, wherein said means for computing said estimated fee further comprises:
a. Means for entering data concerning past projects into a database;
b. Means for accessing said database;
c. Means for comparing said entered project parameters to said past projects in said database to find comparable projects; and
d. Means of computing said fee based on fees associated with said comparable projects.

9. The system of claim 8, wherein said data concerning past projects comprises keywords, and said comparing means compares said keywords to said entered project parameters.

10. The system of claim 1, further comprising:
a. Means for saving said entered project parameters and said calculated fee in a database.

11. A system for use by an entity for tracking personnel-based projects comprising:
a. A computer readable medium comprising computer executable instructions comprising:
i. Means for a user to enter data associated with said entity's organizational structure;
ii. Means for a user to enter parameters associated with said project;
iii. Means for a user to enter estimated workload for personnel within said entity for said project;
iv. Means for indicating that said project is active;
v. Means for storing said parameters and workload in a database; and
vi. Means for accessing said database to locate all such active projects.

12. The system of claim 11, wherein said entered workload comprises hours for each employee within said entity, and further comprising:
a. Means for determining the workload for each employee based on all such active projects, and
b. Means for alerting said user if workload for any of said employees is outside a predetermined range.

13. The system of claim 11, wherein said entered workload comprises hours for each employee within said entity, and said entity's organizational structure comprises associating each employee with a department, and further comprising:
a. Means for determining the workload for each department based on all such active projects, and
b. Means for alerting said user if workload for any of said departments is outside a predetermined range.
